(19) United States
(12) Patent Application Publication
(10) Pub. No.: US 2019/0220670 A1
(43) Pub. Date: Jul. 18, 2019

(54) MOVING IMAGE PROCESSING APPARATUS, MOVING IMAGE PROCESSING METHOD, AND COMPUTER READABLE MEDIUM

(71) Applicant: MITSUBISHI ELECTRIC CORPORATION, Tokyo (JP)

(72) Inventors: Shogo SHIMIZU, Tokyo (JP); Koichi NAKASHIMA, Tokyo (JP); Takashi NISHITSUJI, Tokyo (JP); Katsuhiro KUSANO, Tokyo (JP)

(73) Assignee: MITSUBISHI ELECTRIC CORPORATION, Tokyo (JP)

(21) Appl. No.: 16/302,832

(22) PCT Filed: Jul. 11, 2016
(86) PCT No.: PCT/JP2016/070478

§ 371 Date: Nov. 19, 2018

(51) Int. Cl. G06K 9/00; G06T 7/246; G06K 9/62; G06K 9/44

(52) U.S. Cl. CPC G06K 9/00744; G06T 7/248; G06T 2207/20072; G06K 9/44; G06T 2207/10016; G06K 9/6215

(57) ABSTRACT

An acquisition unit acquires a query feature quantity which is a collection of feature quantities for a query moving image and a feature quantity record which is a collection of feature quantities for a candidate moving image. A similarity map generation unit compares the query feature quantity with the feature quantity record, calculates a similarity between the query feature quantity and the feature quantity record for each of frames of the candidate moving image and generates a similarity sequence in which the similarities are chronologically arranged, and generates a similarity map in which the similarity sequences for the respective frames of the candidate moving image are arranged in order of the frames of the candidate moving image.

### TECHNICAL FIELD

The present invention relates to a moving image processing technique.

### BACKGROUND ART

As an example of a conventional technique for searching for a particular scene in a moving image on the basis of feature quantities calculated from motion vectors extracted from the moving image, there is available a technique disclosed in Patent Literature 1. Patent Literature 1 discloses a technique for, for example, searching for a serving scene in a tennis match image on the basis of a histogram for each angle of motion vectors for a particular range in a moving image.

### CITATION LIST

### Patent Literature

Patent Literature 1: JP 2013-164667A

### SUMMARY OF INVENTION

### Technical Problem

The technique disclosed in Patent Literature 1, however, suffers the problem of the incapability to extract a similar scene in a case where a difference in time length is found in a feature quantity comparison process. For example, in a case where a scene similar to a scene in which a person crosses the screen in 5 seconds is extracted from a moving image, even if a scene of crossing of the screen in 10 seconds is included in the moving image, since the scenes are different in time length, the technique of Patent Literature 1 is incapable of extracting the scene of crossing of the screen in 10 seconds as a similar scene.

The technique disclosed in Patent Literature 1 also suffers the problem of the incapability to extract a similar scene in a case where there is a series of partial mismatches in a feature quantity. For example, in a case where a scene similar to a scene in which a person crosses the screen without stopping is extracted from a moving image, even if a scene in which a person crosses the screen with a stop of several seconds during the crossing is included in the moving image the technique of Patent Literature 1 is incapable of extracting the scene in which the person crosses the screen with a stop of several seconds during the crossing, as a similar scene, due to presence of a series of partial disunities in a feature quantity.

The above-described problems with Patent Literature 1 mean that the technique of Patent Literature 1 is incapable of coping with a disturbance in motion due to a change in the physical condition of a photographic subject or a variation in ambient environment, when a thought is given to an example of application which repeatedly detects human cyclic motions. Given that human cyclic motions do not exactly match throughout their cycles, coping with the problems is fundamental to extraction of a similar scene from a moving image.

The present invention mainly aims at solving the above-described problems. More specifically, the present invention has its major object to extract a similar scene even if a motion as a comparison object has a difference in time length and if there is a series of partial mismatches in a feature quantity during the motion as the comparison object.

### Solution to Problem

A moving image processing apparatus includes:

an acquisition unit to acquire a first feature quantity sequence in which first feature quantities, the first feature quantities being feature quantities generated for respective frames of a first moving image composed of a plurality of frames, are arranged in order of the frames of the first moving image and a second feature quantity sequence in which second feature quantities, the second feature quantities being feature quantities generated for respective frames of a second moving image composed of a plurality of frames larger in number than the plurality of frames of the first moving image, are arranged in order of the frames of the second moving image; and

a similarity map generation unit to compare the first feature quantity sequence with the second feature quantity sequence while moving a comparison object range of the second moving image being an object to be compared with the first feature quantity sequence in the order of the frames of the second moving image, to calculate similarities between the first feature quantities in the first feature quantity sequence and the second feature quantities in the second feature quantity sequence within the comparison object range and generate a similarity sequence in which the similarities are chronologically arranged, for each of the frames of the second moving image, and to generate a similarity map in which the similarity sequences for the respective frames of the second moving image are arranged in the order of the frames of the second moving image.

### Advantageous Effects of Invention

Analysis of a similarity map obtained by the present invention allows extraction of a similar scene even in a case where a motion as a comparison object has a difference in time length and in a case where there is a series of partial mismatches in a feature quantity during the motion as the comparison object.

### BRIEF DESCRIPTION OF DRAWINGS

FIG. 1 is a diagram illustrating an example of a functional configuration of each of moving image processing apparatuses according to Embodiments 1 and 2.

FIG. 2 is a diagram illustrating an example of a hardware configuration of each of the moving image processing apparatuses according to Embodiments 1 and 2.

FIG. 3 is a flowchart illustrating an example of operation of the moving image processing apparatus according to Embodiment 1.

FIG. 4 is a flowchart illustrating an example of operation of the moving image processing apparatus according to Embodiment 2.

FIG. 5 is a diagram illustrating an example of a generated similarity map according to Embodiment 2.

FIG. 6 is a diagram illustrating examples of optimum paths on the similarity map according to Embodiment 2.

FIG. 7 is a diagram illustrating an example of the optimum path on the similarity map according to Embodiment 2.

FIG. 8 is a graph illustrating an example of a similar section estimation method according to Embodiment 2.

FIG. 9 is a diagram illustrating an example of the similarity map according to Embodiment 2.

FIG. 10 is a diagram illustrating an example of the optimum path on the similarity map according to Embodiment 2.

FIG. 11 is a diagram illustrating an example of the optimum path on the similarity map according to Embodiment 2.

### DESCRIPTION OF EMBODIMENTS

Embodiments of the present invention will be described below with reference to the drawings. Parts, to which same reference numerals are assigned, in the following description and the drawings of the embodiments denote same parts or corresponding parts.

### Embodiment 1

The present embodiment will describe a configuration which generates, as a feature quantity, a histogram for each angle of motion vectors extracted from a moving image.

*** Description of Configuration ***

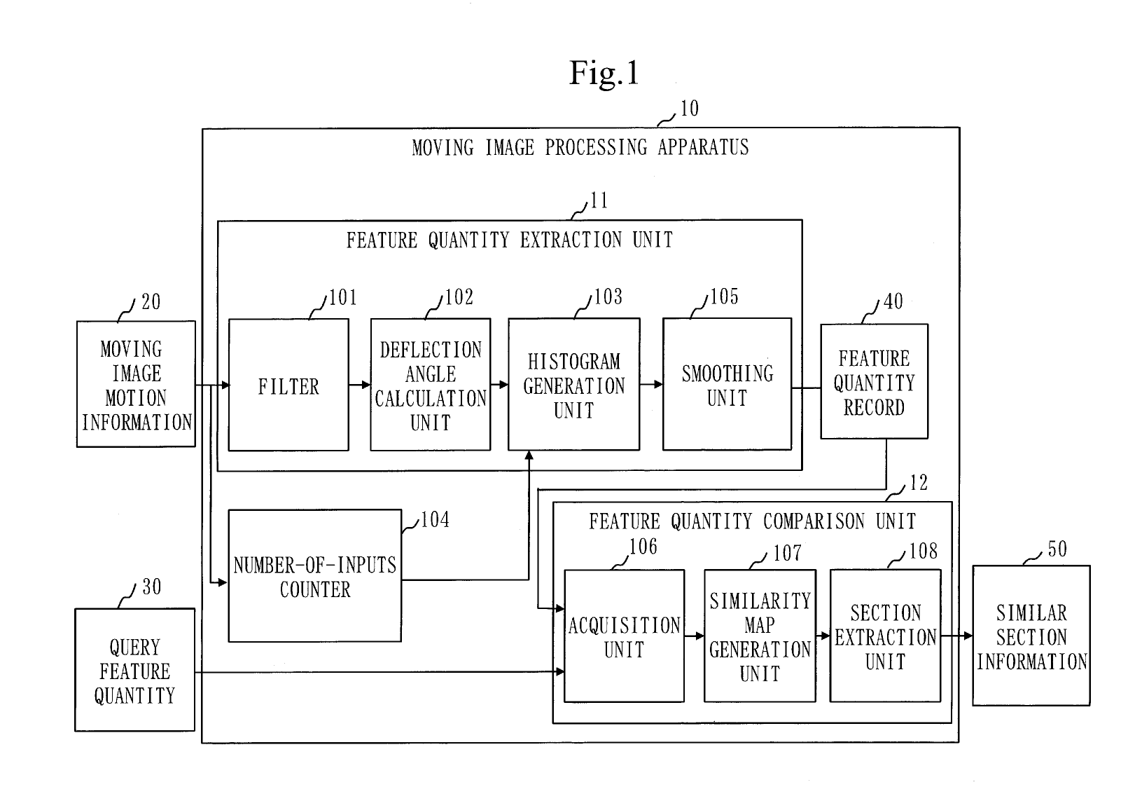

FIG. 1 illustrates an example of a functional configuration of each of moving image processing apparatuses 10 according to Embodiments 1 and 2.

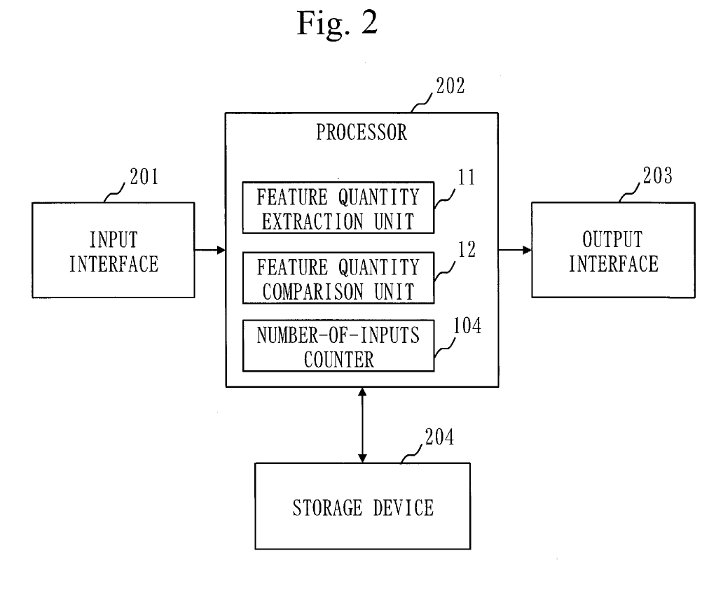

FIG. 2 illustrates an example of a hardware configuration of each of the moving image processing apparatuses 10 according to Embodiments 1 and 2.

Note that operation to be performed by the moving image processing apparatus 10 corresponds to a moving image processing method.

The example of the hardware configuration of the moving image processing apparatus 10 will be described first with reference to FIG. 2.

As illustrated in FIG. 2, the moving image processing apparatus 10 is a computer including an input interface 201, a processor 202, an output interface 203, and a storage device 204.

The input interface 201 acquires, for example, moving image motion information 20 and a query feature quantity 30 illustrated in FIG. 1. The input interface 201 is, for example, an input device, such as a mouse, a keyboard, or the like. If the moving image processing apparatus 10 acquires the moving image motion information 20 and the query feature quantity 30 through communication, the input interface 201 is a communication device. If the moving image processing apparatus 10 acquires the moving image motion information 20 and the query feature quantity 30 as files, the input interface 201 is an interface device with an HDD (Hard Disk Drive).

The processor 202 implements a feature quantity extraction unit 11, a feature quantity comparison unit 12, and a number-of-inputs counter 104 illustrated in FIG. 1. That is, the processor 202 executes a program which implements functions of the feature quantity extraction unit 11, the feature quantity comparison unit 12, and the number-of-inputs counter 104.

FIG. 2 schematically illustrates a state in which the processor 202 is executing the program that implements the functions of the feature quantity extraction unit 11, the feature quantity comparison unit 12, and the number-of-inputs counter 104.

Note that the program that implements the functions of the feature quantity extraction unit 11, the feature quantity comparison unit 12, and the number-of-inputs counter 104 is an example of a moving image processing program.

The processor 202 is an IC (Integrated Circuit) which performs processing and is a CPU (Central Processing Unit), a DSP (Digital Signal Processor), or the like.

The storage device 204 stores the program that implements the functions of the feature quantity extraction unit 11, the feature quantity comparison unit 12, and the number-of-inputs counter 104.

The storage device 204 is a RAM (Random Access Memory), a ROM (Read Only Memory), a flash memory, an HDD, or the like.

The output interface 203 outputs an analysis result from the processor 202. The output interface 203 is, for example, a display. If the moving image processing apparatus 10 transmits an analysis result from the processor 202, the output interface 203 is a communication device. If the moving image processing apparatus 10 outputs an analysis result from the processor 202 as a file, the output interface 203 is an interface device with an HDD.

The example of the functional configuration of the moving image processing apparatus 10 will next be described with reference to FIG. 1.

Note that the present embodiment will describe only the moving image motion information 20, the feature quantity extraction unit 11, and the number-of-inputs counter 104 and that Embodiment 2 will describe the query feature quantity 30, a feature quantity record 40, the feature quantity comparison unit 12, and similar section information 50.

The moving image motion information 20 is information indicating a motion vector extracted from a moving image.

The feature quantity extraction unit 11 is composed of a filter 101, a deflection angle calculation unit 102, a histogram generation unit 103, and a smoothing unit 105.

The filter 101 selects moving image motion information 20 that meets a predetermined condition from among the moving image motion information 20 acquired via the input interface 201. The filter 101 outputs the selected moving image motion information 20 to the deflection angle calculation unit 102.

The deflection angle calculation unit 102 calculates deflection angle components of motion vectors for the moving image motion information 20 acquired from the filter 101, for each of frames included in a moving image. The deflection angle calculation unit 102 outputs calculation results to the histogram generation unit 103.

Note that a process to be performed by the deflection angle calculation unit 102 corresponds to a deflection angle calculation process.

The histogram generation unit 103 generates, for each frame, histogram data for the deflection angle components using the results of calculating the deflection angle components from the deflection angle calculation unit 102. The histogram generation unit 103 notifies the smoothing unit 105 of completion of the histogram data upon output of a processing start notification from the number-of-inputs counter 104.

Note that a process to be performed by the histogram generation unit 103 corresponds to a histogram generation process.

The number-of-inputs counter 104 counts the moving image motion information 20 acquired by the input interface 201. The number-of-inputs counter 104 outputs the processing start notification to the histogram generation unit 103 if the moving image motion information 20 for one frame of the moving image is input.

The smoothing unit 105 acquires the histogram data, performs smoothing on the acquired histogram data, and generates a feature quantity.

The smoothing unit 105 stores the generated feature quantity as the feature quantity record 40 in the storage device 204. Details of the feature quantity record 40 will be described in Embodiment 2.

*** Description of Operation ***

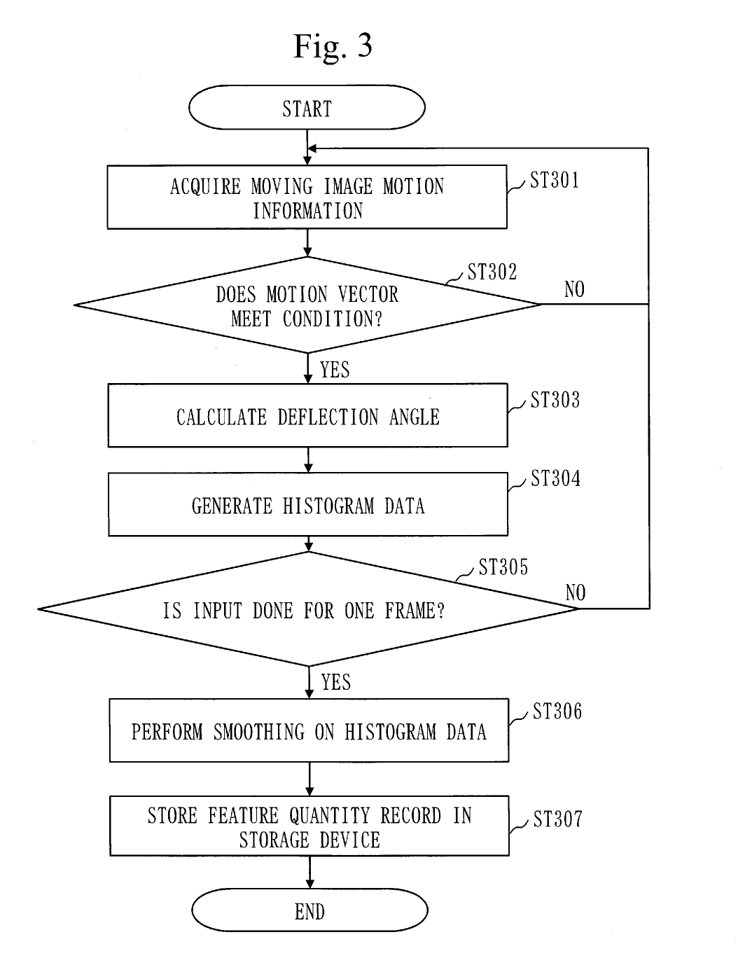

An example of operation of the moving image processing apparatus 10 according to the present embodiment will next be described with reference to a flowchart in FIG. 3.

The filter 101 acquires the moving image motion information 20 indicating a motion vector which is extracted from a moving image shot by a digital camera, a network camera, or the like, via the input interface 201 (step ST301). The moving image motion information 20 acquired by the filter 101 indicates a motion vector which is calculated on a per-pixel-block basis from, for example, a luminance gradient between neighboring moving image frames, like a coded motion vector specified in MPEG (Moving Picture Expert Group) or the like.

The filter 101 then determines whether the motion vector indicated in the acquired moving image motion information 20 meets the predetermined condition (step ST302). The filter 101 outputs the moving image motion information 20 for the motion vector meeting the condition, to the deflection angle calculation unit 102.

Examples of the condition used by the filter 101 are a condition on an upper limit value and a condition on a lower limit value for a norm of a motion vector.

The deflection angle calculation unit 102 calculates a deflection angle component of the motion vector of the moving image motion information 20 output from the filter 101 (step ST303).

The deflection angle calculation unit 102 then outputs a calculation result to the histogram generation unit 103.

The histogram generation unit 103 counts a frequency with which deflection angle component calculation results are acquired from the deflection angle calculation unit 102 on a per-angle basis and generates histogram data (step ST304). The histogram generation unit 103 accumulates the histogram data in the storage device 204.

The number-of-inputs counter 104 counts the moving image motion information 20 acquired by the input interface 201. When the moving image motion information 20 for one frame of the moving image have been input, the number-of-inputs counter 104 outputs the processing start notification to the histogram generation unit 103 (step ST305).

The histogram generation unit 103 notifies the smoothing unit 105 of completion of histogram data, using the processing start notification from the number-of-inputs counter 104 as a trigger.

When the smoothing unit 105 is notified of the completion of the histogram data by the histogram generation unit 103, the smoothing unit 105 acquires the histogram data from the storage device 204 and performs smoothing on the acquired histogram data (step ST306).

The smoothing unit 105, for example, performs smoothing using histogram data generated by the histogram generation unit 103 for an arbitrary number of consecutive frames preceding to the acquired histogram data and generates a feature quantity.

More specifically, the smoothing unit 105 performs smoothing by applying weights according to time distances between the frame for which a feature quantity is to be generated, (the frame corresponding to the histogram data acquired from the storage device 204) and the arbitrary number of preceding frames, to each of the histogram data for the arbitrary number of preceding frames.

Finally, the smoothing unit 105 stores data after the smoothing (the feature quantity) as the feature quantity record 40 in the storage device 204 (step ST307).

*** Description of Advantageous Effects of Embodiment ***

The technique of Patent Literature 1 suffers the problem of the incapability to extract a similar scene in a case where there is a scale difference in a motion as a comparison object.

According to the present embodiment, a histogram is generated from only deflection angle components of motion vectors to obtain a feature quantity. It is thus possible to extract a similar scene even in a case where there is a scale difference in a motion as a comparison object.

### Embodiment 2

The present embodiment will describe a configuration which extracts a similar section in a moving image by calculating a similarity through comparison of feature quantities extracted from two or more moving images and estimating a section with a longest series of high similarities by a matching method in which a thought is given to a difference in time length or a series of partial mismatches, such as dynamic programming.

*** Description of Configuration ***

The present embodiment will describe a query feature quantity 30, a feature quantity record 40, a feature quantity comparison unit 12, and similar section information 50 illustrated in FIG. 1.

The query feature quantity 30 is a feature quantity sequence. More specifically, the query feature quantity 30 is a feature quantity sequence in which feature quantities generated for respective frames of a query moving image composed of a plurality of frames are arranged in the order of the frames of the query moving image. The query moving image is a moving image which represents a motion as a search object.

For example, if the query moving image is composed of 300 frames, 300 feature quantities are arranged in the order of the frames in the query feature quantity 30.

Each of the feature quantities constituting the query feature quantity 30 is a feature quantity (histogram data after leveling) which is generated by the same method as the generation method described in Embodiment 1.

The query moving image corresponds to a first moving image. The query feature quantity 30 corresponds to a first feature quantity sequence. A feature quantity for each frame of the query moving image corresponds to a first feature quantity.

The feature quantity record 40 is also a feature quantity sequence. The feature quantity record 40 is a feature quantity sequence in which feature quantities (histogram data after leveling) generated for respective frames of a candidate moving image are arranged in the order of the frames of the candidate moving image.

The candidate moving image is a moving image which may include a same motion as or a similar motion to the motion represented by the query moving image. The candidate moving image is composed of a plurality of frames larger in number than those of the query moving image.

For example, if the candidate moving image is composed of 3000 frames, 3000 feature quantities are arranged in the order of the frames in the feature quantity record 40.

The feature quantity record 40 is generated by the feature quantity extraction unit 11 described in Embodiment 1.

The candidate moving image corresponds to a second moving image. The feature quantity record 40 corresponds to a second feature quantity sequence.

Additionally, a feature quantity for each frame of the feature quantity record 40 corresponds to a second feature quantity.

The feature quantity comparison unit 12 is composed of an acquisition unit 106, a similarity map generation unit 107, and a section extraction unit 108.

The acquisition unit 106 acquires the query feature quantity 30 via an input interface 201. The acquisition unit 106 also acquires the feature quantity record 40 from a storage device 204. The acquisition unit 106 then outputs the acquired query feature quantity 30 and the acquired feature quantity record 40 to the similarity map generation unit 107.

A process to be performed by the acquisition unit 106 corresponds to an acquisition process.

The similarity map generation unit 107 compares the query feature quantity 30 with the feature quantity record 40. More specifically, the similarity map generation unit 107 compares the query feature quantity 30 with the feature quantity record 40 while moving a comparison object range of the candidate moving image as an object to be compared with the query feature quantity 30 according to the order of the frames of the candidate moving image.

The similarity map generation unit 107 then calculates, for each of the frames of the candidate moving image, a similarity between a feature quantity in the query feature quantity 30 and a feature quantity in the feature quantity record 40 for the comparison object range to generate a similarity sequence in which similarities are chronologically arranged.

The similarity map generation unit 107 further generates a similarity map by arranging similarity sequences for the respective frames of the candidate moving image in the order of the frames of the candidate moving image. That is, the similarity map is two-dimensional similarity information, in which the similarity sequences for the respective frames of the candidate moving image are arranged in the order of the frames of the candidate moving image.

A process to be performed by the similarity map generation unit 107 corresponds to a similarity map generation process.

The section extraction unit 108 analyzes the similarity map and extracts a similar section which is a section with frames of the candidate moving image representing a same motion as or a similar motion to the motion represented by the query moving image. The similar section corresponds to a corresponding section.

The similar section information 50 is information indicating the similar section extracted by the section extraction unit 108.

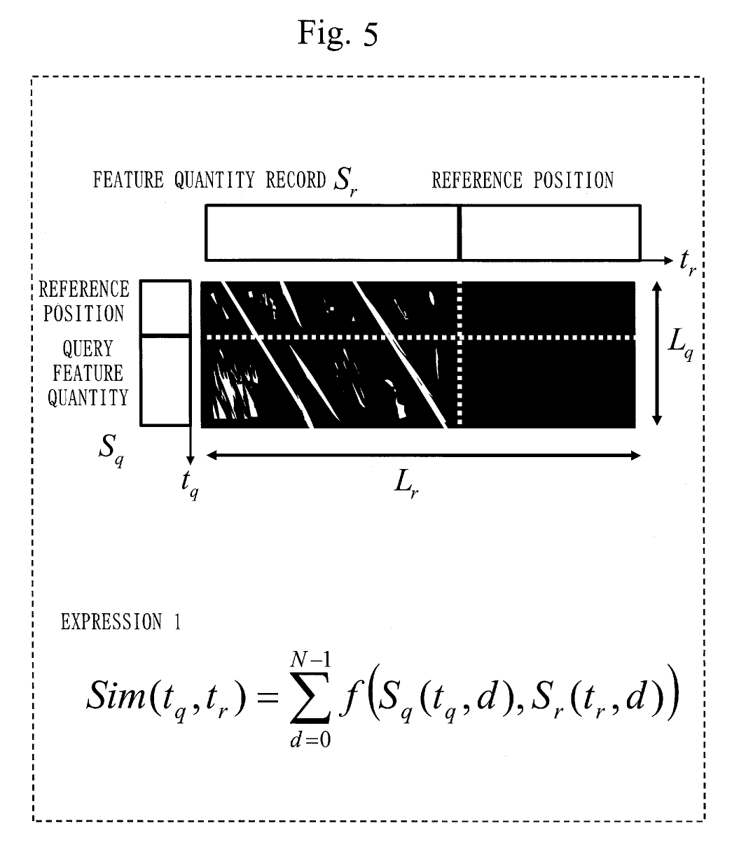

FIG. 5 illustrates an example of a similarity map.

FIG. 5 illustrates a procedure for generating a similarity map of a feature quantity record Sᵣ having a frame count of Lᵣ (0≤L_{q}≤Lᵣ) with respect to a query feature quantity S_{q} having a frame count of L_{q}.

The similarity map generation unit 107 shifts a start frame of a comparison object range (L_{q} frames) by one frame in the order of frames of the feature quantity record Sᵣ at a time, compares a feature quantity of each frame within the comparison object range with a feature quantity of a frame at a corresponding position of the query feature quantity S_{q}, and calculates a similarity on a per-frame basis.

That is, at the time of comparison with the comparison object range starting from a 0-th frame L₀ of the feature quantity record Sᵣ (frames L₀ to L_{q-1}), the similarity map generation unit 107 compares the frame L₀ of the feature quantity record Sᵣ with a 0-th frame Lₒ of the query feature quantity S_{q} and calculates a similarity. The similarity map generation unit 107 then compares the first frame L₁ of the feature quantity record Sᵣ with a first frame L₁ of the query feature quantity S_{q} and calculates a similarity. The similarity map generation unit 107 makes similar comparisons for the frame L₂ and subsequent frames.

After comparison between the frame L_{q-1} of the feature quantity record Sᵣ and a frame L_{q-1} of the query feature quantity S_{q} ends, the similarity map generation unit 107 makes a comparison with the comparison object range starting from the first frame L₁ of the feature quantity record Sᵣ (frames L₁ to L_{q}). At the time of the comparison with the comparison object range starting from the first frame L₁ of the feature quantity record Sᵣ (the frames L₁ to L_{q}), the similarity map generation unit 107 compares the frame L₁ of the feature quantity record Sᵣ with the 0-th frame Lₒ of the query feature quantity S_{q} and calculates a similarity. The similarity map generation unit 107 then compares the frame L₂ of the feature quantity record Sᵣ with the first frame L₁ of the query feature quantity S_{q} and calculates a similarity. The similarity map generation unit 107 makes similar comparisons for the frame L₂ and subsequent frames.

After comparison between the frame L_{q} of the feature quantity record Sᵣ and the frame L_{q-1} of the query feature quantity S_{q} ends, the similarity map generation unit 107 makes a comparison with the comparison object range starting from the second frame L₂ of the feature quantity record Sᵣ (frames L₂ to L_{q+1}). After that, the similarity map generation unit 107 repeats similar processing until a frame L_{r-q}. A similarity map is obtained by arranging similarity sequences for respective comparison object ranges obtained by the above-described processing in the order of the frames of the feature quantity record Sᵣ.

Assume that a time axis for the query feature quantity S_{q} is t_{q} (0≤t_{q}<L_{q}), a time axis for the feature quantity record Sᵣ is tᵣ (0≤tᵣ<Lᵣ), and the number of feature quantity dimensions is N, a similarity Sim between the query feature quantity S_{q} and the feature quantity record Sᵣ is given as a function of the time axes by the following expression:

$$\begin{matrix}FORMULA 1 & \\ Sim ( {t}_{q} , {t}_{r} ) = {\sum }_{d = 0}^{N - 1} f ( {S}_{q} ( {t}_{q} , d ) , {S}_{r} ( {t}_{r} , d ) ) & ( 1 )\end{matrix}$$

Here, the function f is a function which calculates each dimensional similarity between feature quantities. For example, a cosine similarity or the like can be used. A filter intended for noise reduction or emphasis can be used for a similarity. Similarity contrast can be emphasized by, for example, adding weights to similarities for several neighboring frames and integrating the similarities, and using an exponential function filter.

As can be seen from the above, the similarity map generation unit 107 calculates similarities for two or more feature quantities, generates a similarity map, and stores the generated similarity map in the storage device 204. Additionally, the similarity map generation unit 107 notifies the section extraction unit 108 of the generation of the similarity map.

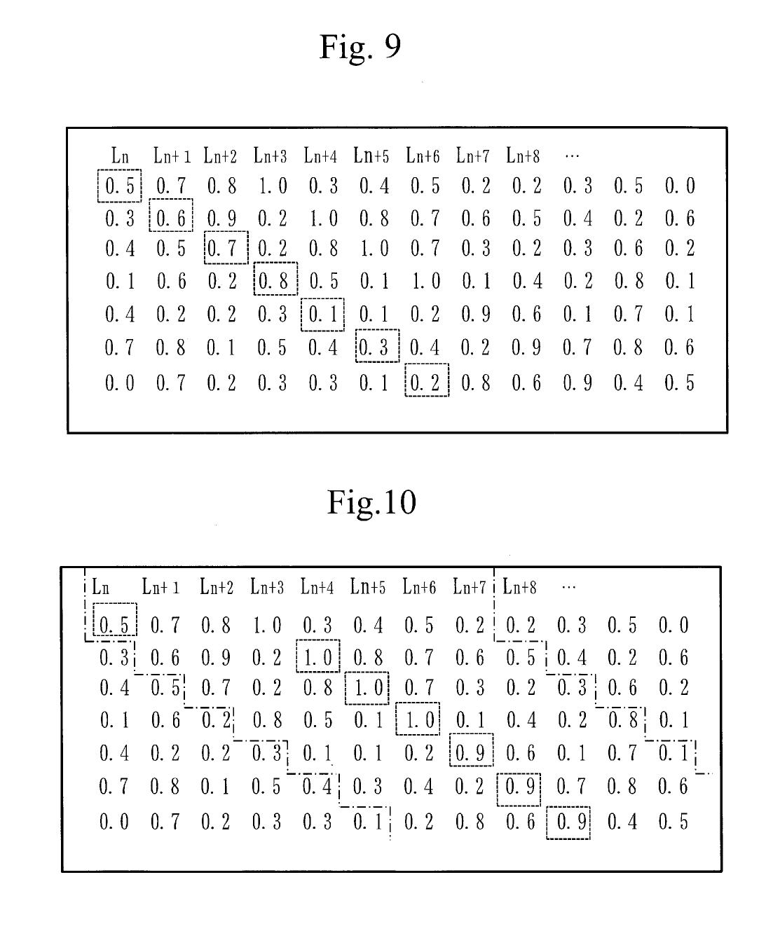

Note that although the similarity map generation unit 107 generates a similarity map being picture image data in the example in FIG. 5, the similarity map generation unit 107 may generate a similarity map being numerical data, as illustrated in FIG. 9.

In FIG. 9, a sequence of numerical values surrounded by broken lines indicates a sequence of similarities between the comparison object range starting from an n-th frame Lₙ of the feature quantity record Sᵣ (frames Lₙ to L_{n+q-1}) and the frames L₀ to L_{q-1} of the query feature quantity S_{q}. Note that, in the example in FIG. 9, similarity values range from 0.0 to 1.0. Lₙ, Lₙ₊₁, Lₙ₊₂, and the like illustrated in FIG. 9 are attached for explanation and are not included in an actual similarity map.

*** Description of Operation ***

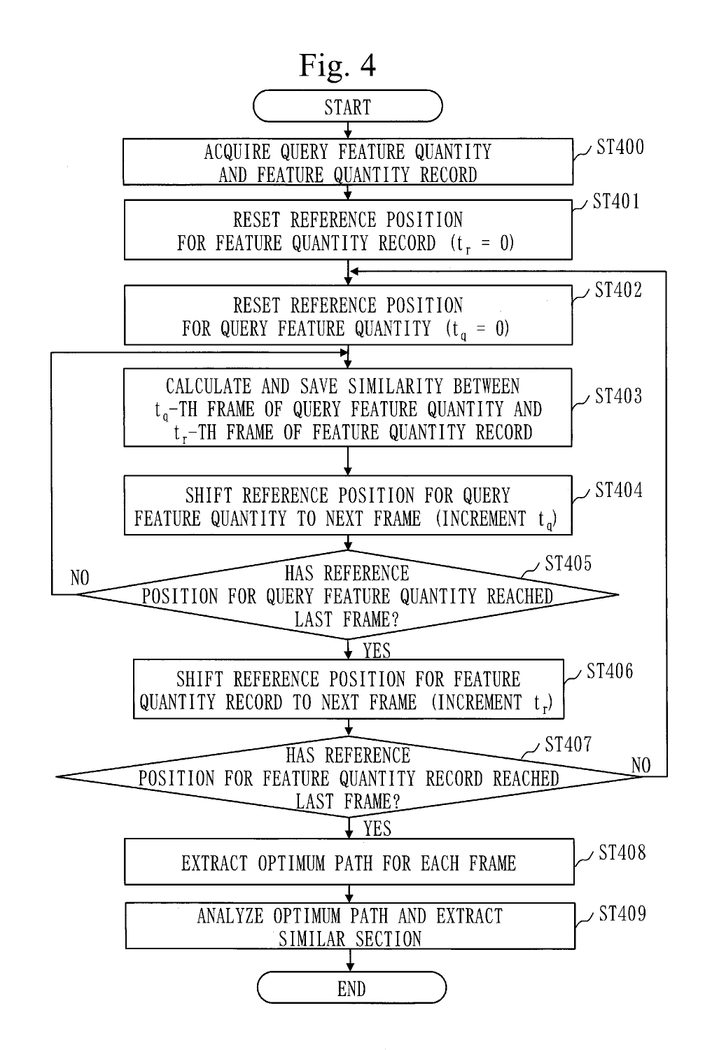

An example of operation of the moving image processing apparatus 10 according to the present embodiment will next be described with reference to FIG. 4.

The acquisition unit 106 first acquires the query feature quantity 30 and the feature quantity record 40 (step ST401). As described earlier, the acquisition unit 106 acquires the query feature quantity 30 via the input interface 201 and acquires the feature quantity record 40 from the storage device 204. The acquisition unit 106 then outputs the acquired query feature quantity 30 and the acquired feature quantity record 40 to the similarity map generation unit 107.

The similarity map generation unit 107 then sets reference frame positions for the feature quantity record 40 and the query feature quantity 30 to respective start points tᵣ=0 and t_{q}=0 (steps ST401 and ST402).

The similarity map generation unit 107 then fixes the reference position for the feature quantity record 40, and calculates a similarity at each time point according to expression (1) while moving the reference position for the query feature quantity 30 by one frame at a time. The similarity map generation unit 107 saves the calculated similarities in the storage device 204 (steps ST403 and ST404).

If the reference position for the query feature quantity 30 reaches an end (YES in step ST405), the similarity map generation unit 107 shifts the reference position for the feature quantity record 40 to a frame adjacent in a forward direction (step ST406) and repeats the processes in steps ST402 to ST405.

If the reference position for the feature quantity record 40 reaches an end (YES in step ST407), the similarity map generation unit 107 provides notification of processing completion to the section extraction unit 108.

The section extraction unit 108 acquires the notification from the similarity map generation unit 107, reads out a similarity map from the storage device 204, and extracts an optimum path from the similarity map (step ST408).

More specifically, the section extraction unit 108 extracts, as an optimum path, a path with a highest similarity within a predetermined range w starting from each frame of the feature quantity record 40 from the similarity map.

In the similarity map in FIG. 5, the level of a similarity is represented so as to correspond to the brightness of an image. If the similarity map in FIG. 5 is used, the section extraction unit 108 extracts an optimum path by detecting a high-brightness portion which extends linearly from top to bottom right of the similarity map within the predetermined range w starting from each frame of the feature quantity record 40. That is, the section extraction unit 108 selects a path with a highest integrated similarity value within the predetermined range w starting from each frame of the feature quantity record 40 in the similarity map.

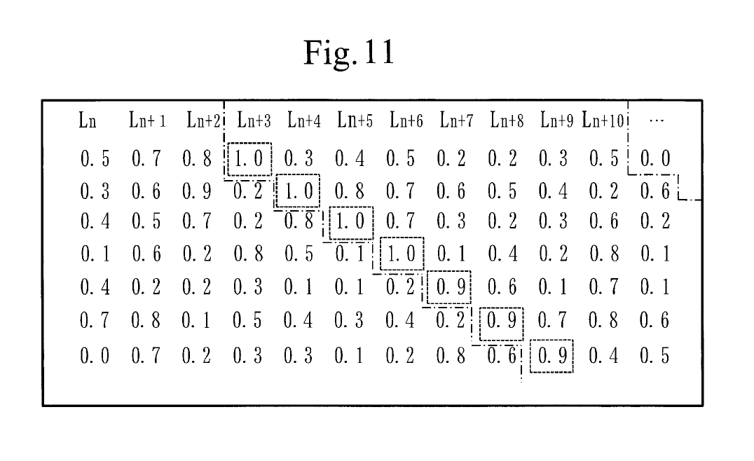

A procedure for extracting an optimum path by the section extraction unit 108 will be described with reference to FIGS. 10 and 11.

FIG. 10 illustrates a procedure for extracting an optimum path for the frame Lₙ.

FIG. 11 illustrates a procedure for extracting an optimum path for the frame Lₙ₊₃.

Note that the predetermined range w=7 in FIGS. 10 and 11. That is, in FIG. 10, the section extraction unit 108 extracts an optimum path within a range (Lₙ to Lₙ₊₇) composed of the frame Lₙ and seven frames subsequent to the frame Lₙ. In FIG. 11, the section extraction unit 108 extracts an optimum path within a range (frames Lₙ₊₃ to Lₙ₊₁₀) composed of the frame Lₙ₊₃ and seven frames subsequent to the frame Lₙ₊₃. Note that, in FIGS. 10 and 11, ranges surrounded by alternate long and short dash lines are optimum path extraction ranges.

As illustrated in FIG. 10, the section extraction unit 108 selects a similarity with a highest value in each row. Note that a leftmost similarity is selected in a first row. In FIG. 10, a similarity surrounded by a broken line is a similarity with a highest value. A path obtained by connecting similarities (similarities surrounded by broken lines in FIG. 10) with highest values selected in respective rows as described above is an optimum path. That is, an optimum path is a path with a highest integrated similarity value which is selected from among a similarity sequence for each frame and similarity sequences for frames within the predetermined range w subsequent to the frame. Note that the range surrounded by the alternate long and short dash lines in FIG. 10 is an optimum path extraction range.

If an optimum path extending at 45 degrees from top left to bottom right is obtained, as in FIG. 11, a motion represented by the query moving image and a motion represented by a similar section in the candidate moving image corresponding to the optimum path are coincident in time length. For example, if the query moving image represents a scene in which a person crosses the screen in 5 seconds, and the optimum path as in FIG. 11 is obtained, the similar section in the candidate moving image corresponding to the optimum path also represents a scene in which a person crosses the screen in 5 seconds.

The section extraction unit 108 shifts a frame, for which an optimum path is to be extracted, from Lₙ, to Lₙ₊₁, then to Lₙ₊₂, . . . , and sequentially extracts an optimum path for each frame.

The section extraction unit 108, for example, estimates a plurality of optimum paths in the similarity map across an entire region of the feature quantity record 40, using dynamic programming.

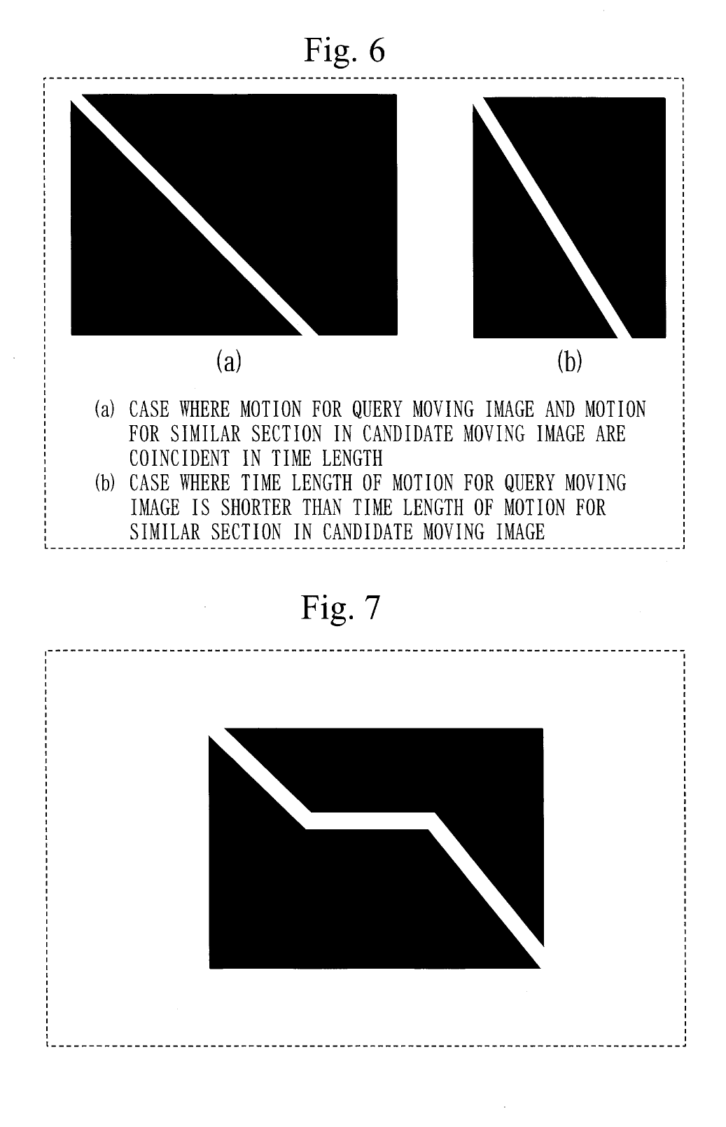

Since dynamic programming is used, even if there is a difference in time length between the motion represented by the query moving image and a similar motion in the candidate moving image (FIG. 6), the section extraction unit 108 can extract a similar section. Additionally, since dynamic programming is used, even if there is a section with partial continuous mismatches between the motion represented by the query moving image and a similar motion in the candidate moving image (FIG. 7), the section extraction unit 108 can extract a similar section.

FIGS. 6 and 7 illustrate optimum paths extracted from a similarity map represented as a picture image as illustrated in FIG. 5. In FIGS. 6 and 7, a white line represents an optimum path.

An optimum path in (a) of FIG. 6 is an optimum path extending at 45 degrees from top left to bottom right, like the optimum path in FIG. 11. For this reason, a motion represented by a similar section in the candidate moving image corresponding to the optimum path in (a) of FIG. 6 is coincident in time length with the motion represented by the query moving image.

If an optimum path in (b) of FIG. 6 is obtained, a time length of the motion for the query moving image is shorter than a time length of a motion for a similar section in the candidate moving image. For example, if the query moving image represents a scene in which a person crosses the screen in 5 seconds, and the optimum path as in (b) of FIG. 6 is obtained, a similar section in the candidate moving image corresponding to the optimum path represents a scene in which a person crosses the screen in 10 seconds.

An optimum path in FIG. 7 includes a horizontal path inserted into a path extending at 45 degrees from top left to bottom right. If the optimum path in FIG. 7 is obtained, a motion represented by a similar section in the candidate image corresponding to the optimum path includes the motion represented by the query moving image and a motion not represented by the query moving image. For example, if the query moving image represents a scene in which a person crosses the screen without stopping, and the optimum path as in FIG. 7 is obtained, a similar section in the candidate moving image corresponding to the optimum path represents a scene in which a person crosses the screen with a stop of several seconds during the crossing.

When the optimum paths are extracted in the above-described manner, the section extraction unit 108 then analyzes the optimum paths and extracts a similar section from the candidate moving image (step ST409 in FIG. 4).

The section extraction unit 108 then outputs a similar section extraction result as the similar section information 50 from the output interface 203.

The section extraction unit 108 extracts a similar section representing a same motion as or a similar motion to the motion for the query moving image from the candidate moving image on the basis of a feature in a waveform of integrated similarity values for the optimum paths for the respective frames.

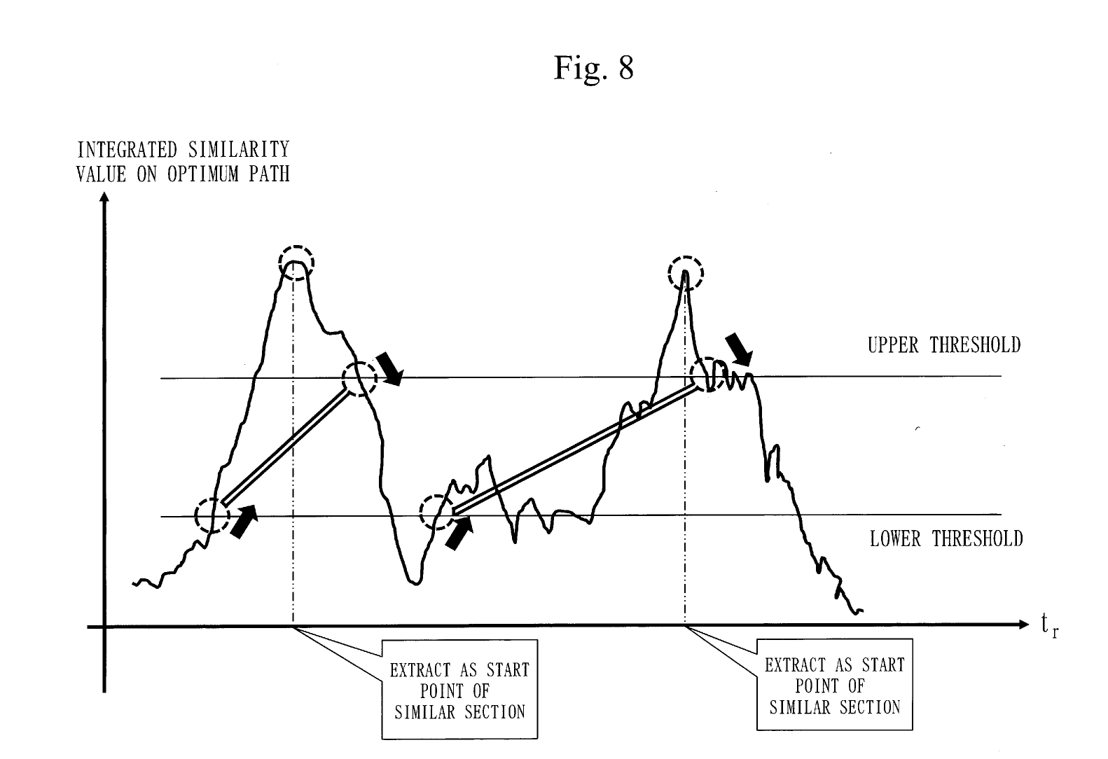

A procedure for extracting a similar section will be described with reference to FIG. 8.

FIG. 8 illustrates a waveform of the integrated similarity values obtained by plotting the integrated similarity values for the optimum paths for the respective frames of the candidate moving image in the order of the frames of the candidate moving image.

The abscissa Tᵣ in FIG. 8 corresponds to a frame number for the candidate moving image.

The section extraction unit 108 estimates a most probable section from the waveform in FIG. 8 in order to select an optimum similar section from among a plurality of optimum paths. That is, the section extraction unit 108 estimates a similar section by obtaining a portion where the integrated similarity values are higher overall than in surroundings in the waveform in FIG. 8. The section extraction unit 108 extracts a similar section by, for example, a method which sets an upper threshold and a lower threshold, as illustrated in FIG. 8, and detects a rise of the waveform. That is, the section extraction unit 108 extracts, as a start point of a similar section, a frame of the candidate moving image corresponding to a local maximum for the integrated similarity values between where the integrated similarity value rises above the lower threshold and where the integrated similarity value falls below the upper threshold in the waveform in FIG. 8.

The upper threshold and the lower threshold may be dynamically changed on the basis of a motion amount over the entire moving image and a histogram pattern.

*** Description of Advantageous Effects of Embodiment ***

Use of a similarity map described in the present embodiment allows extraction of a similar scene even in a case where a motion as a comparison object has a difference in time length and in a case where there is a series of partial mismatches in a feature quantity during the motion as the comparison object.

A section similar to a particular motion can be extracted from a moving image shot over a long time even in the presence of time extension and shortening and a partial difference. This allows shortening of a time period required for moving image search.

The embodiments of the present invention have been described above. These two embodiments may be combined and carried out.

Alternatively, one of the two embodiments may be partially carried out.

Alternatively, the two embodiments may be partially combined and carried out.

Note that the present invention is not limited to the embodiments and that the embodiments can be variously changed, as needed.

For example, in Embodiment 2, the feature quantity comparison unit 12 extracts a similar section from a candidate moving image using a feature quantity generated by the feature quantity extraction unit 11 described in Embodiment 1, that is, a feature quantity based on a deflection angle component of a motion vector. The feature quantity comparison unit 12, however, may extract a similar section from a candidate moving image using a feature quantity based on a deflection angle component and a norm of a motion vector.

*** Description of Hardware Configuration ***

Finally, a supplemental explanation of the hardware configuration of the moving image processing apparatus 10 will be given.

The storage device 204 illustrated in FIG. 2 stores an OS (Operating System) in addition to a program which implements functions of the feature quantity extraction unit 11, the feature quantity comparison unit 12, and the number-of-inputs counter 104.

At least a part of the OS is then executed by the processor 202.

The processor 202 executes the program which implements functions of the feature quantity extraction unit 11, the feature quantity comparison unit 12, and the number-of-inputs counter 104 while executing at least a part of the OS.

The processor 202 executes the OS, thereby performing task management, memory management, file management, communication control, and the like.

Information, data, signal values, and variable values indicating results of processing by the feature quantity extraction unit 11, the feature quantity comparison unit 12, and the number-of-inputs counter 104 are stored in at least any of the storage device 204 and a register and a cache memory inside the processor 202.

The program that implements the functions of the feature quantity extraction unit 11, the feature quantity comparison unit 12, and the number-of-inputs counter 104 may be stored in a portable storage medium, such as a magnetic disk, a flexible disk, an optical disc, a compact disc, a Blu-ray (a registered trademark) disc, or a DVD.

The “unit” in each of the feature quantity extraction unit 11 and the feature quantity comparison unit 12 may be replaced with the “circuit”, the “step”, the “procedure”, or the “process”.

The moving image processing apparatus 10 may be implemented as an electronic circuit, such as a logic IC (Integrated Circuit), a GA (Gate Array), an ASIC (Application Specific Integrated Circuit), or an FPGA (Field-Programmable Gate Array).

In this case, the feature quantity extraction unit 11, the feature quantity comparison unit 12, and the number-of-inputs counter 104 are each implemented as a portion of the electronic circuit.

Note that the processor and the above-described electronic circuit are also generically called processing circuitry.

### REFERENCE SIGNS LIST

10: moving image processing apparatus; 11: feature quantity extraction unit; 12: feature quantity comparison unit; 20: moving image motion information; 30: query feature quantity; 40: feature quantity record; 50: similar section information; 101: filter; 102: deflection angle calculation unit; 103: histogram generation unit; 104: number-of-inputs counter; 105: smoothing unit; 106: acquisition unit; 107: similarity map generation unit; 108: section extraction unit; 201: input interface; 202: processor; 203: output interface; 204: storage device

1. A moving image processing apparatus comprising:
processing circuitry to:
acquire a first feature quantity sequence in which first feature quantities, the first feature quantities being feature quantities generated for respective frames of a first moving image composed of a plurality of frames, are arranged in order of the frames of the first moving image and a second feature quantity sequence in which second feature quantities, the second feature quantities being feature quantities generated for respective frames of a second moving image composed of a plurality of frames larger in number than the plurality of frames of the first moving image, are arranged in order of the frames of the second moving image; and
compare the first feature quantity sequence with the second feature quantity sequence while moving a comparison object range of the second moving image being an object to be compared with the first feature quantity sequence in the order of the frames of the second moving image, to calculate similarities between the first feature quantities in the first feature quantity sequence and the second feature quantities in the second feature quantity sequence within the comparison object range and generate a similarity sequence in which the similarities are chronologically arranged, for each of the frames of the second moving image, and generate a similarity map in which the similarity sequences for the respective frames of the second moving image are arranged in the order of the frames of the second moving image.

2. The moving image processing apparatus according to claim 1, wherein
the processing circuitry analyzes the similarity map and extracts a corresponding section, the corresponding section being a section of a frame of the second moving image which represents a same motion as or a similar motion to a motion represented by the first moving image.

3. The moving image processing apparatus according to claim 2, wherein
the processing circuitry
extracts, for each of the frames of the second moving image, an optimum path, the optimum path being a path with a highest integrated similarity value, from among the similarity sequence for the frame and the similarity sequences for frames within a predetermined range subsequent to the frame in the similarity map, and
analyzes the integrated similarity values for the optimum paths for the respective frames of the second moving image and extracts the corresponding section.

4. The moving image processing apparatus according to claim 3, wherein
the processing circuitry extracts, as a start point of the corresponding section, a frame of the second moving image which corresponds to a local maximum for the integrated similarity values between where the integrated similarity value rises above a lower threshold and where the integrated similarity value falls below an upper threshold in a waveform of the integrated similarity values obtained by plotting the integrated similarity values for the respective optimum paths in the order of the frames of the second moving image.

5. The moving image processing apparatus according to claim 3, wherein
the processing circuitry extracts the optimum path for each of the frames of the second moving image using dynamic programming.

6. The moving image processing apparatus according to claim 1, wherein
the processing circuitry acquires the first feature quantity sequence, in which the first feature quantities, the first feature quantities being feature quantities based on deflection angle components of motion vectors extracted from the respective frames of the first moving image, are arranged in the order of the frames of the first moving image and the second feature quantity sequence, in which the second feature quantities, the second feature quantities being feature quantities based on deflection angle components of motion vectors extracted from the respective frames of the second moving image, are arranged in the order of the frames of the second moving image.

7. The moving image processing apparatus according to claim 1, wherein
the processing circuitry
calculates a deflection angle component of a motion vector for each of frames included in a moving image; and
generates deflection angle component histogram data for each of the frames using a result of calculating the deflection angle components.

8. The moving image processing apparatus according to claim 7, wherein
the processing circuitry
performs, on the deflection angle component histogram data generated, smoothing using the deflection angle component histogram data generated for an arbitrary number of preceding consecutive frames and generates a feature quantity.

9. The moving image processing apparatus according to claim 8, wherein
the processing circuitry performs the smoothing by applying weights according to time distances between the frame for which the feature quantity is to be generated, and each of the arbitrary number of frames to each of the deflection angle component histogram data for the arbitrary number of frames.

10. A moving image processing method comprising:
acquiring a first feature quantity sequence in which first feature quantities, the first feature quantities being feature quantities generated for respective frames of a first moving image composed of a plurality of frames, are arranged in order of the frames of the first moving image and a second feature quantity sequence in which second feature quantities, the second feature quantities being feature quantities generated for respective frames of a second moving image composed of a plurality of frames larger in number than the plurality of frames of the first moving image, are arranged in order of the frames of the second moving image; and
comparing the first feature quantity sequence with the second feature quantity sequence while moving a comparison object range of the second moving image being an object to be compared with the first feature quantity sequence in the order of the frames of the second moving image, calculating similarities between the first feature quantities in the first feature quantity sequence and the second feature quantities in the second feature quantity sequence within the comparison object range and generating a similarity sequence in which the similarities are chronologically arranged, for each of the frames of the second moving image, and generating a similarity map in which the similarity sequences for the respective frames of the second moving image are arranged in the order of the frames of the second moving image.

11. The moving image processing method according to claim 10, further comprising:
calculating a deflection angle component of a motion vector for each of frames included in a moving image; and
generating deflection angle component histogram data for each of the frames using a result of calculating the deflection angle components.

12. A non-transitory computer readable medium storing a moving image processing program that causes a computer to execute:
an acquisition process of acquiring a first feature quantity sequence in which first feature quantities, the first feature quantities being feature quantities generated for respective frames of a first moving image composed of a plurality of frames, are arranged in order of the frames of the first moving image and a second feature quantity sequence in which second feature quantities, the second feature quantities being feature quantities generated for respective frames of a second moving image composed of a plurality of frames larger in number than the plurality of frames of the first moving image, are arranged in order of the frames of the second moving image; and
a similarity map generation process of comparing the first feature quantity sequence with the second feature quantity sequence while moving a comparison object range of the second moving image being an object to be compared with the first feature quantity sequence in the order of the frames of the second moving image, calculating similarities between the first feature quantities in the first feature quantity sequence and the second feature quantities in the second feature quantity sequence within the comparison object range and generating a similarity sequence in which the similarities are chronologically arranged, for each of the frames of the second moving image, and generating a similarity map in which the similarity sequences for the respective frames of the second moving image are arranged in the order of the frames of the second moving image.

13. The non-transitory computer readable medium according to claim 12,
wherein
the moving image processing program further causes the computer to execute:
a deflection angle calculation process of calculating a deflection angle component of a motion vector for each of frames included in a moving image; and
a histogram generation process of generating deflection angle component histogram data for each of the frames using a result of calculating the deflection angle components in the deflection angle calculation process.
